(19) United States
(12) Patent Application Publication
(10) Pub. No.: US 2002/0042719 A1
(43) Pub. Date: Apr. 11, 2002

(54) Process for preparing a trademark application

(76) Inventors: Marc Chauchard, Le Chesnay (FR); Olivier Barloy, Paris (FR)

Correspondence Address: Finnegan, Henderson, Farabow,, Garrett & Dunner, L.L.P., 1300 I Street, N.W., Washington, DC, 20005-3315, US

(21) Appl. No.: 09/964,753

(22) Filed: Sep. 28, 2001

(30) Foreign Application Priority Data
Sep. 29, 2000 (FR) 00 12397

(51) Int. Cl. G06F 17/60

(52) U.S. Cl. 705/1

(57) ABSTRACT

Process for preparing a trademark application, by means of a local computer capable of being connected to a remote computer via a computer network of the Internet type, including the following steps, performed on the local computer:

(i) entering the trademark,

(ii) selecting the products or services to which the trademark applies,

(iii) validating the entry and the selection,

(iv) sending the validated entry and selection to the remote computer via the computer network,

said steps being carried out in the order indicated.

The present invention relates to a process for preparing a trademark application, using a local computer capable of being connected to a remote computer by a computer network of the Internet type.

A trademark application contains the identity of the applicant, the trademark model and a list of the products or services to which it applies, as well as the enumeration of the corresponding official classes.

Once it has been prepared, the application is filed or transmitted to the competent administrative department which is, in France, the Institut National de la Propriété Industrielle (the French Patent Office), which examines it with a view to registering it.

The applicant can use the services of a specialist attorney, such as a member of the Compagnie Nationale des Conseils en Propriété Industrielle.

The preparation of a trademark application is, indeed, an operation that involves taking numerous parameters into consideration.

First of all, it is essential, prior to the filing of the application, to carry out availability searches to avoid infringing the rights of third parties; the performance and interpretation of such searches are tasks that are extremely complex, owing to the prior rights of varying relevance that may exist, for example among the corporate names or among trademarks already filed.

The latter may be French trademarks, international trademarks designating France, or again Community trademarks.

One of the greatest difficulties, however, resides in the enumeration of the products or services to which a trademark applies, as well as in the enumeration of the corresponding official classes and their numbers.

The products or services to which a trademark applies depend on the applicant's objectives, and the choice of their wording is, in actual fact, practically unlimited.

For example, a trademark can designate a software package, which is a general formulation, or a software package for handling the movements of a computer mouse via an infrared link, which is far more precise.

To take another example, a trademark can designate clothes, which is a general formulation, or bathing suits for practising underwater hockey, which is specific.

The choice of the wording or wordings for products or services depends directly on the projects the applicant has in mind, and on the intended use of the trademark.

A clear understanding of the applicant's objectives can be obtained when the latter has recourse to the services of specialist consultants.

Numerous parameters, sometimes mutually opposed, must, indeed, be taken into consideration: a study of the portfolio of trademarks already filed by the applicant, the short, medium and long-term views of the applicant's plans, knowledge of the competitors and of the market, with its trends, the national and international situation on the market in question, the cost outlay for research on and the creation of the new trademark, the overall budget for the operation of filing and obtaining the trademark, in France and abroad, the medium and long-term effects on the applicant's portfolio of trademarks, monitoring and trademark watch procedures to be set up, future opposition proceedings and defence of the rights acquired, the integration of the current project in the overall strategy of the applicant or of its company, etc.

In each of the fields mentioned above, the applicant can decide to call on the services of specialist consultants, each one in his or her particular discipline.

With particular reference to the preparation of a trademark application case, the choice of wordings to which the trademark applies and the enumeration of the classes corresponding to the products or services concerned can be a particularly arduous mental exercise in certain cases.

The World Intellectual Property Organisation has prepared for this purpose, over the years, a guide on the international classification of products and services for the purpose of registering trademarks, also referred to hereinafter as the ‘international trademark classification’.

This guide, which is periodically revised, contains several thousands of wordings, distributed over forty-two official classes, whereof thirty-four, numbered from 1 to 34, relate to the products, and eight, numbered from 35 to 42, relate to the services.

To each class corresponds an official heading, which very schematically represents the general field with which the class is concerned, but some classes relate to products or services that are very diverse, for example classes 1, 3, 5, 9, 16, 21, 28, 30, 35 or 42.

It is not always easy to establish the correspondence between the products or services and the classes to which they correspond.

For example, a software package is a class 9 product, and computer programming is a class 42 service; but computer repair is a class 37 service; legal consulting belongs to class 42, whereas law manuals are to be found in class 16, while legal training services fall within class 41.

Other examples could be quoted but we know that what is important nowadays is to make the description of a patent application as concise, precise and compact as possible, so as to cut down drafting, and possibly translation costs.

It will be noted, to conclude, that the complexity of a trademark application file may cause the applicant to call on the services of a member of the Compagnie Nationale des Conseils en Propriété Industrielle.

Certain multinational companies file numerous trademark applications each year and have decided to set up their own internal intellectual property departments.

Objective financial surveys have shown, however, that the standing costs generated by the permanent running of such an internal deparment often exceed those deriving from recourse to outside attorneys; it is also true that said internal departments also perform other useful assignments, for example when negotiating licences, and that they increasingly have recourse, moreover, to sub-contracting, in all fields of management.

The fact nonetheless remains that recourse to outside consultants, however justified it may seem to certain applicants, leads to billing that increases the cost of a trademark filing.

It must be admitted, however, that such billing is fairly moderate by comparison with the costs involved in the creation of a new trademark and the publicity used to launch it.

At all events, we have seen that the preparation of a trademark application is an operation of a definitely technical nature, which generates costs, including the official fees levied by the national or international administrative departments responsible for examining the applications with a view to registering them.

It is thus desirable to remedy these drawbacks and offer applicants new means to facilitate their action and reduce their costs.

The present invention has precisely this dual objective, and relates to a process as defined in the first paragraph of the present description, which is characterised in that it includes the following steps, carried out on a local computer:

(i) entering the trademark,

(ii) selecting the products or services to which the trademark applies,

(iii) validating the entry and the selection,

(iv) sending the validated entry and selection to the remote computer via the computer network,

said steps being carried out in the order indicated.

It is thus easier to prepare a trademark application, and the case is swiftly transmitted to the remote computer with a view to action being taken.

This remote computer can be installed on the premises of a member of the Compagnie Nationale des Conseils en Propriété Industrielle or on those of a computer company.

According to one particular form of embodiment, at least one step is implemented through cooperation between the local computer and the remote computer.

This cooperation makes it possible to use the process interactively or sharing the resources of the computers; the local computer can also be a terminal, the computer resources then being concentrated at the remote computer.

According to another particular form of embodiment of the invention, the validated entry and selection are re-transmitted from the remote computer to another remote computer by electronic mail.

It is thus possible to transmit by electronic mail to another remote computer a message enabling the application case to be prosecuted.

Said other, remote computer can be installed on the premises of a member of the Compagnie Nationale de la Propriété Industrielle.

Advantageously, the entry stage includes the operation consisting in scanning the model of the trademark.

This arrangement is useful when the trademark is a device trademark or a word and device trademark.

Preferably, the sending step includes transmitting to the remote computer the model of the trademark scanned, via the computer netwwork.

In this way, the remote computer receives the information on the representation of the trademark; arrangements can also be made to re-transmit the model of the scanned trademark, by electronic mail, from the remote computer to a second remote computer.

According to one particular form of embodiment, the selection step includes the choice of the heading of at least one official class of products or services and the display of the corresponding number of the class.

It is thus possible to select en bloc one or several official class(es) of products or services.

According to another particular form of embodiment, the selection stage includes the choice of at least one number of an official class of products or services and the display of the corresponding heading of the class.

It is thus possible to select an official class directly by its number.

According to another preferred form of embodiment of the invention, the selection step includes:

(i) entering at least one freely chosen wording,

(ii) comparing said freely chosen wording with potential wordings contained in a file,

(iii) displaying, following said comparison, one or more wording(s) proposed from among the potential wordings,

(iv) selecting at least one wording from among the wording(s) proposed,

(v) displaying the number of the official class corresponding to the wording(s) selected.

It is thus easier to select the products or services, as well as to determine the official class corresponding to the wording(s) selected and the corresponding numbers of the class or classes.

Preferably, the file comprises the wordings of the official classification of the trademarks and the number of the class corresponding to each wording.

The wordings selected will thus, in theory, be accepted by the administrative departments responsible for examining the trademark applications.

Advantageously, the file further comprises additional wordings not featuring in the official classification of trademarks and the number of the class corresponding to each of these additional wordings.

It is thus possible to have at one's disposal additional wordings entered in the file and corresponding to specific or new products or services, or those for which there is reason to suppose that they will be introduced into the international classification of products of services for the purpose of registering trademarks.

Advantageously, the selection step includes the use of a comparison software package, this software making it possible to display a proposed wording identical with the wording freely chosen or a proposed wording including the freely chosen wording or a proposed wording synonymous with the freely chosen wording or one or the other of the above choices, optionally or sequentially.

It is thus possible to narrow down or widen the choice of proposed wordings.

The invention can be implemented in different ways, examples of some of which are given below.

An operator has the intention of preparing a trademark registration application.

It is assumed that the operator is the applicant.

This description also applies to the case of the applicant being a company represented by the operator, who may be, for example, a member of staff, and also applies to the case of the applicant being another person or a plurality of individuals and/or companies represented by the operator.

The latter has at his disposal a local computer capable of being connected to a remote computer by a computer network of the Internet type, this local computer being connected to a scanner.

The remote computer comprises a file containing the wordings of the international classification of products and services for the purpose of registering trademarks, the headings of the official classes and the number corresponding to each wording and to each class; the file also contains additional wordings not featuring in the above classification and the class corresponding to each of these additional wordings; these additional wordings have been entered in the file, for example, by the intellectual property attorney of the applicant.

This description equally applies to the use of other computer networks, telematics, radio or cable networks, the term ‘network’ being used in its broadest sense, including networks for transmission by satellite or local loops or networks or those internal to organisations or companies.

The user connects to the remote computer and identifies him or herself by entering an identifier and a password.

Once the identifer and the password have been validated, the user accesses a user account.

This user account may be provided with the necessary information on the identity of the applicant: surname, first name, address, nationality, etc., corporate name, legal form, address of head office, and other information of use in applying for registration such as, for example, the colour of the trademark, but this information can be provided at a prior or a later stage.

A number of non-limitative examples of implementation of the process according to the invention are given below:

First example: the operator performs the following steps, in the order indicated.

He enters the trademark to be filed, for example: “LOGOPOLE”.

He selects the following heading: “vehicles, apparatus for locomotion by land, air or water”, and the corresponding class number is displayed: “12”.

This selection stage includes the use of a software package enabling the headings of the official classes and their numbers to be displayed.

The operator validates the entry and the selection, and proceeds to send the validated entry and selection to the remote computer.

The steps of the process are implemented by cooperation, via the computer network, between the local computer and the remote computer.

Second example: during the above entry step, the operator scans the model of the trademark to be filed, and, during the sending step, he transmits the model of the scanned model to the remote computer.

The steps of the process are implemented by cooperation, via the data processing network, between the local computer and the remote computer.

Third example: the operator performs the following steps, in the order indicated.

He enters the trademark to be filed, for example: “LOGOPOLE”.

He selects the number “12” of an official class of products or services, and the corresponding heading, namely “vehicles, apparatus for locomotion by land, air or water” is displayed.

This selection step includes the use of a software package permitting the display of the number of the official classes, as well as their headings.

The operator validates the entry and the selection and proceeds to send the validated entry and selection to the remote computer.

The steps of the process are implemented through cooperation, via the computer network, between the local computer and the remote computer.

Fourth example: the operator performs the following steps, in the order indicated.

He enters the trademark to be filed, for example: “LOGOPOLE”.

Then he enters a freely chosen products or services wording, which is intended to be designated by the trademark, for example: “TRUCKS”.

The following proposed wording is displayed: “TRUCKS”.

It is to be noted that this wording is identical with that chosen by the operator.

The latter selects the proposed wording, and the number “12” of the class corresponding to the wording selected is displayed.

This selection step includes making use of a comparison software package enabling a proposed wording identical with the freely chosen wording to be displayed.

The operator validates the entry and the selection and proceeds to send the validated entry and selection to the remote computer.

The steps of the process are implemented through cooperation, via the data processing network, between the local computer and the remote computer.

Fifth example: the operator performs the following steps, in the order indicated.

He enters the trademark to be filed, for example: “LOGOPOLE”.

Then, he enters a freely chosen products or services wording, which is intended to be designated by the trademark, for example: “TRUCKS”.

The following proposed wordings are displayed: TRUCK BODIES, TRUCKS”.

It will be noted that the proposed wording includes the wording freely chosen.

The operator selects the wording “TRUCK BODIES”, and the number of the official class is displayed, i.e. “12”.

This selection stage includes the use of a comparison software package permitting the display of the proposed wordings including the wording freely chosen.

The operator validates the entry and the selection, and proceeds to send the validated entry and selection to the remote computer.

The process steps are implemented, by cooperation, via the computer network, between the local computer and the remote computer.

Sixth example: the operator performs the following steps, in the order indicated.

He enters the trademark to be filed, for example: “LOGOPOLE”.

Then, he enters a freely chosen products or services wording, which is intended to be designated by the trademark, for example: “TRUCKS”.

The following proposed wordings are displayed: “TRUCK BODIES, VANS, TRUCKS, TRUCKING”.

It will be noted that the wordings proposed include the freely chosen wording, in the singular and in the plural.

This selection step includes the use of a comparison software package making it possible to display the proposed wordings including in the singular and in the plural the freely chosen wording.

The operator selects the wordings “TRUCKS, VANS, TRUCKING”, and the official class numbers are displayed: “12, 12, 39”, respectively.

The operator validates the entry and the selection, and proceeds to send the validated entry and selection to the remote computer.

The steps of the process are implemented through cooperation, via the computer network, between the local computer and the remote computer.

Seventh example: the operator performs the following steps, in the order indicated.

He enters the trademark to be filed, for example: “LOGOPOLE”.

Then, he enters a freely chosen products or services wording, which is intended to be designated by the trademark, for example: “TRUCKS”.

The following proposed wordings are displayed: “TRUCK BODIES, VANS, TRUCKS, TRUCKING, TRUCK REPAIR”.

It will be noted that the proposed wordings include the freely chosen wording, in the singular, and the additional wording “TRUCK REPAIR”, which does not feature in the international trademark classification.

This selection step includes the use of a comparison software package making it possible to display the proposed wordings including in the singular and in the plural the freely chosen wording, the proposed wordings being taken from among the wordings of the international classification of the trademarks and from among the additional wordings.

The operator selects the wordings “TRUCKS, TRUCK REPAIR”, and the official class numbers, “12, 37”, respectively, are displayed.

The operator validates the entry and the selection and proceeds to send the validated entry and the selection to the remote computer.

The steps of the process are implementd through cooperation, via the computer network, between the local computer and the remote computer.

Eighth example: the operator performs the following steps, in the order indicated below.

He enters the trademark to be filed, for example: “LOGOPOLE”.

Then he enters a freely chosen products or services wording,that is to be designated by the trademark, for example: “TRUCKS”.

The following proposed wordings are displayed: “TRUCK BODIES, VANS, TRUCKS, TRUCKING, TRUCK REPAIR, HEAVY TRUCKS, VEHICLES”.

It is to be noted that the proposed wordings include the freely chosen wording, in the singular and in the plural, and the additional wordings “TRUCK REPAIR, HEAVY TRUCKS, VEHICLES”.

The wording “HEAVY TRUCKS” is similar to “TRUCKS”; the wording “VEHICLES” is conceptually broader than “TRUCKS”.

This selection step includes the use of a comparison software package permitting the display of the proposed wordings including, in the singular and in the plural, the freely chosen wording, the proposed wordings being taken from among the wordings of the international trademark classification and from among the additional wordings, and including proposed wordings similar to the freely chosen wording.

The operator selects the wordings “VEHICLES, TRUCK REPAIR”, and the numbers of the official classes are displayed, “12, 37”, respectively.

The steps of the process are implemented through cooperation, via the computer network, between the local computer and the remote computer.

The operator validates the entry and the selection and proceeds to send the validated entry and selection to the remote computer.

Ninth example: in this case, it is the local computer that contains the file of wordings of the international classification of products and services for trademark registration purposes, the headings of the official classes and the number corresponding to each wording and to each class; the file also contains additional wordings not featuring in the international trademark classification and the class number corresponding to each of these additional wordings.

According to one variant, the local computer has the information that may possibly already be contained in the operator's user account.

The preceding examples can be reproduced and, in this case, the operator, following validation of the entry and the selection, proceeds to send the validated entry and selection to the remote computer.

It will be noted that connection to the remote computer may take place at any time prior to the sending of the validated entry and selection.

According to one variant, the user proceeds to re-transmit to the remote computer information contained in the user account, which completes the trademark application preparation file.

According to another variant of each of the foregoing examples, the remote computer is capable of sending messages to a second remote computer by electronic mail; it is thus possible to re-transmit the validated entry and selection to the second computer, together with information contained in the user account; when this information, accompanied by the validated entry and selection, is sufficient, preparation of the trademark filing case is complete; it may then be appropriate for it to be revised by a member of the Compagnie Nationale des Conseils en Propriété Industrielle.

This is facilitated when the remote computer, or the second remote computer, is installed on the premises of the intellectual property attorney.

1. Process for preparing a trademark registration application, by means of a local computer capable of being connected to a remote computer via a computer network of the Internet type, characterised in that it includes the following steps, performed on the local computer:
(i) entering the trademark,
(ii) selecting the products or services to which the trademark applies,
(iii) validating the entry and the selection,
(iv) sending the validated entry and selection to the remote computer via the computer network,
said steps being carried out in the order indicated.

2. Process according to claim 1, characterised in that at least one step is implemented through cooperation between the local computer and the remote computer.

3. Process according to claim 1 or 2, characterised in that the validated entry and selection are re-transmitted from the remote computer to another remote computer, by electronic mail.

4. Process according to any one of claims 1 to 3, characterised in that the entry step includes the operation consisting in scanning the model of the trademark.

5. Process according to claim 4, characterised in that the sending step includes transmission to the remote computer of the scanned model of the trademark, via the computer network.

6. Process according to any one of claims 1 to 5, characterised in that the selection step includes the choice of the heading of at least one official class of products or services and the display of the corresponding number of the class.

7. Process according to any one of claims 1 to 5, characterised in that the selection step includes the choice of at least one number of an official class of products or services and the display of the corresponding heading of the class.

8. Process according to any one of claims 1 to 5, characterised in that the selection step includes:
(i) entering at least one freely chosen wording,
(ii) comparing said freely chosen wording with the potential wordings contained in a file,
(iii) displaying, following said comparison, one or more wording(s) proposed from among the potential wordings,
(iv) selecting at least one wording from among the wording(s) proposed,
(v) displaying the number of the official class corresponding to the wording(s) selected.

9. Process according to claim 8, characterised in that the file contains the wordings of the official classification of trademarks and the number of the class corresponding to each wording.

10. Process according to claim 9, characterised in that the file further includes additional wordings not featuring in the official classification of trademarks and the number of the class corresponding to each of these additional wordings.

11. Process according to any one of claims 8 to 10, characterised in that the selection step includes the use of a comparison software package, this software permitting the display of a proposed wording identical with the freely chosen wording.

12. Process according to claim 11, characterised in that the comparison software permits the display of a proposed wording including the freely chosen wording.

13. Process according to claim 12, characterised in that the comparison software permits the display of a proposed wording synonymous with the freely chosen wording.
